(19) United States
(12) Patent Application Publication
(10) Pub. No.: US 2026/0219381 A1
(43) Pub. Date: Jul. 30, 2026

(54) PROCEDURES TO REPORT SINR AND/OR RSSI WITH APPLICATION-DEPENDENT GRANULARITY IN WLAN SENSING

(71) Applicant: InterDigital Patent Holdings, Inc., Wilmington, DE (US)

(72) Inventors: Mahmoud SAAD, Montreal (CA); Zinan LIN, Basking Ridge, NJ (US); Rui YANG, Melville, NY (US)

(73) Assignee: InterDigital Patent Holdings, Inc., Wilmington, DE (US)

(21) Appl. No.: 19/143,601

(22) PCT Filed: Jan. 12, 2024
(86) PCT No.: PCT/US2024/011375

§ 371 Date: Jun. 26, 2025

Related U.S. Application Data
(60) Provisional application No. 63/438,696, filed on Jan. 12, 2023.
(60) Provisional application No. 63/439,467, filed on Jan. 17, 2023.

(51) Int. Cl. G01S 13/76; G01S 7/00

(52) U.S. Cl. CPC G01S 13/765; G01S 7/006

(57) ABSTRACT

Systems, methods, and devices may address reporting information, such as channel state information, received signal strength indication, signal to noise ratio, signal to interference and/or noise ratio, and/or the like, with application or scenario dependent granularity for wireless local area network sensing between an initiator and a responder.

### CROSS-REFERENCE TO RELATED APPLICATIONS

This application claims the benefit of U.S. Provisional Application No. 63/438,696, filed Jan. 12, 2023, and U.S. Provisional Application No. 63/439,467, filed Jan. 17, 2023, the contents of which are incorporated herein by reference.

### BACKGROUND

In a wireless local area network, access points and/or stations may need to perform sensing in order for the wireless local area network to perform efficiently. There is a need for novel, improved, and/or enhanced approaches for performing this sensing.

### SUMMARY

Systems, methods, and devices may address reporting information, such as channel state information, received signal strength indication, signal to noise ratio, signal to interference and/or noise ratio, and/or the like, with application or scenario dependent granularity for wireless local area network sensing between an initiator and a responder.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates an example of a sensing measurement setup request frame action field format;

FIG. 3 illustrates an example of a sensing measurement setup response frame action field format;

FIG. 4 illustrates an example of a sensing measurement parameters element format;

FIG. 5 illustrates an example design of a presence and control bitmap field format for the reporting of the RSSI;

FIG. 6 illustrates an example design of a sensing measurement report control field for the reporting of the RSSI;

FIG. 7 illustrates an example design of a presence and control bitmap field format for the reporting of the SINR;

FIG. 8 illustrates an example design of a sensing measurement report control field for the reporting of the SINR;

FIG. 9 illustrates an example procedure to indicate if the RSSI and/or SINR measurement is required and the granularity of the measurement;

FIG. 10 illustrates an example design of a sensing measurement parameters field format to indicate if the RSSI and/or the SINR is required and the corresponding granularity;

FIG. 11 illustrates an example of a sensing measurement parameters field format to indicate if the SNR is required and the corresponding min and max SNR values;

FIG. 12 illustrates an example of an enhanced sensing element format; and

FIG. 13 illustrates an example of an enhanced sensing field format.

### DETAILED DESCRIPTION

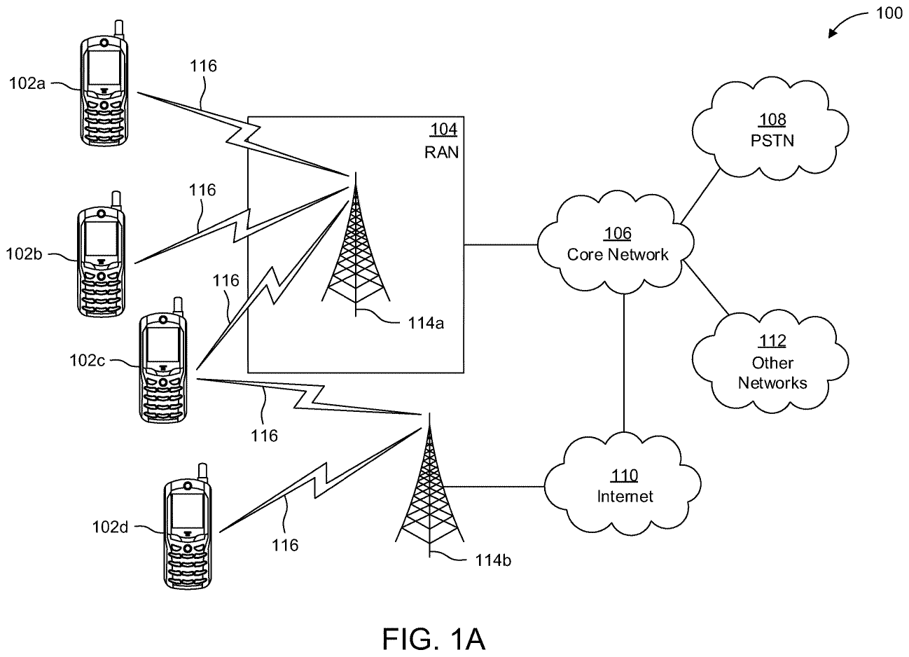

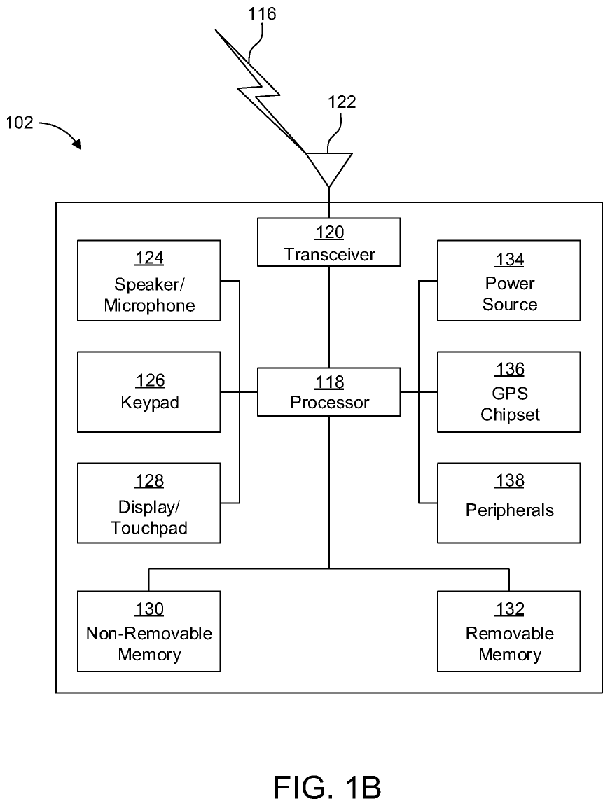

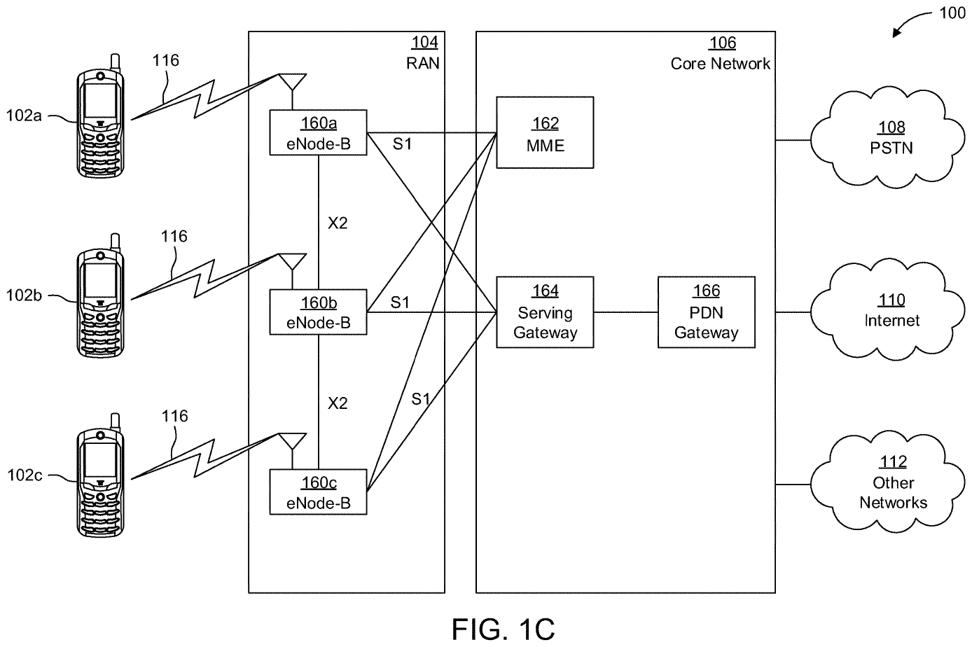

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In some embodiments, the other network 112 of FIGS. 1A-1D may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

As discussed above, FIGS. 1A-1D may represent a WLAN scenario in one example. A WLAN in Infrastructure Basic Service Set (BSS) mode may have one or more Access Points (APs) for the BSS and one or more stations (STAs)/WTRUs associated with the AP. As discussed herein, a WTRU and STA may be interchangeable. The AP may have access or interface to a Distribution System (DS) or another type of wired/wireless network that carries traffic in and out of the BSS. Traffic to STAs that originate from outside the BSS may arrive through the AP (e.g., serving as a gateway and a router) and may be subsequently delivered to one or more STAs. Traffic originating from STAs to destinations outside the BSS may be sent to the AP to be delivered to the respective destinations. Traffic between STAs within the BSS may also be sent through the AP where the source STA sends traffic to the AP and the AP delivers the traffic to the destination STA.

In 802.11ac infrastructure mode of operation, the AP may transmit a beacon on a fixed channel, usually the primary channel. This channel may be 20 MHz wide, and is the operating channel of the BSS. This channel is also used by the STAs to establish a connection with the AP. The fundamental channel access mechanism in an 802.11 system is Carrier Sense Multiple Access with Collision Avoidance (CSMA/CA). In this mode of operation, every STA, including the AP, will sense the primary channel. If the channel is detected to be busy, the STA backs off. Hence only one STA may transmit at any given time in a given BSS.

In 802.11n, High Throughput (HT) STAs may also use a 40 MHz wide channel for communication. This is achieved by combining the primary 20 MHz channel, with an adjacent 20 MHz channel to form a 40 MHz wide contiguous channel.

In 802.11ac, Very High Throughput (VHT) STAs may support 20 MHz, 40 MHz, 80 MHz, and 160 MHz wide channels. The 40 MHz, and 80 MHz, channels are formed by combining contiguous 20 MHz channels similar to 802.11n described above. A 160 MHz channel may be formed either by combining 8 contiguous 20 MHz channels, or by combining two non-contiguous 80 MHz channels, which may also be referred to as an 80+80 configuration. For the 80+80 configuration, the data, after channel encoding, is passed through a segment parser that divides it into two streams. The Inverse Discrete Fourier Transformation (IDFT) operation and time domain processing are done on each stream separately. The streams are then mapped on to the two channels, and the data is transmitted. At the receiver, this mechanism is reversed, and the combined data is sent to the MAC.

To improve spectral efficiency, in a given operating mode (e.g., 802.11ac, etc.) there may be downlink Multi-User MIMO (MU-MIMO) transmission to multiple STA's in the same symbol's time frame (e.g., during a downlink OFDM symbol). In some cases, as a result of downlink MU-MIMO using the same symbol timing to multiple STA's, interference of the waveform transmissions to multiple STA's may not be an issue. However, all STA's involved in MU-MIMO transmission with the AP may need to use the same channel or band, thus limiting the operating bandwidth to the smallest channel bandwidth that is supported by the STA's which are included in the MU-MIMO transmission with the AP.

In WLAN Sensing, the sensing measurement report may include CSI measured for the environment. It may be beneficial to include the received signal strength indicator (RSSI) measurement for each receive antenna and/or the received Signal to Interference plus Noise ratio (SINR) for each transmitted spatial stream. However, problems may arise in that different sensing applications or different sensing scenarios for the same application may require different granularity for these measurements depending on the accuracy requirements for each sensing application or each sensing scenario for the same application. How to report the RSSI and/or SINR with different granularity in the sensing measurement report needs to be addressed. Note, while SINR and RSSI are used for demonstration purposes herein, one or both of these terms may be interchangeable with signal to noise ratio (SNR).

There is a need to improve wireless sensing capability in WLAN. In one or more operation modes for a WLAN (e.g., 802.11bf, etc.) there may be: a sensing procedure that allows a STA to perform WLAN sensing and obtain measurement results; a sensing session that is an instance of a sensing procedure with associated operational parameters of that instance; a sensing initiator, which may be a STA or other devices that initiates a WLAN sensing session; a sensing responder, which may be a STA or other device that participates in a WLAN sensing session initiated by a sensing initiator; a sensing transmitter, which may be a STA or other devices that transmits PPDUs used for sensing measurements in a sensing session; a sensing receiver, which may be a STA or other devices that receives PPDUs sent by a sensing transmitter and performs sensing measurements in a sensing session; and/or, a STA or other device that may assume multiple roles in one sensing session, where in a sensing session a sensing initiator may be a sensing transmitter, a sensing receiver, both, or neither.

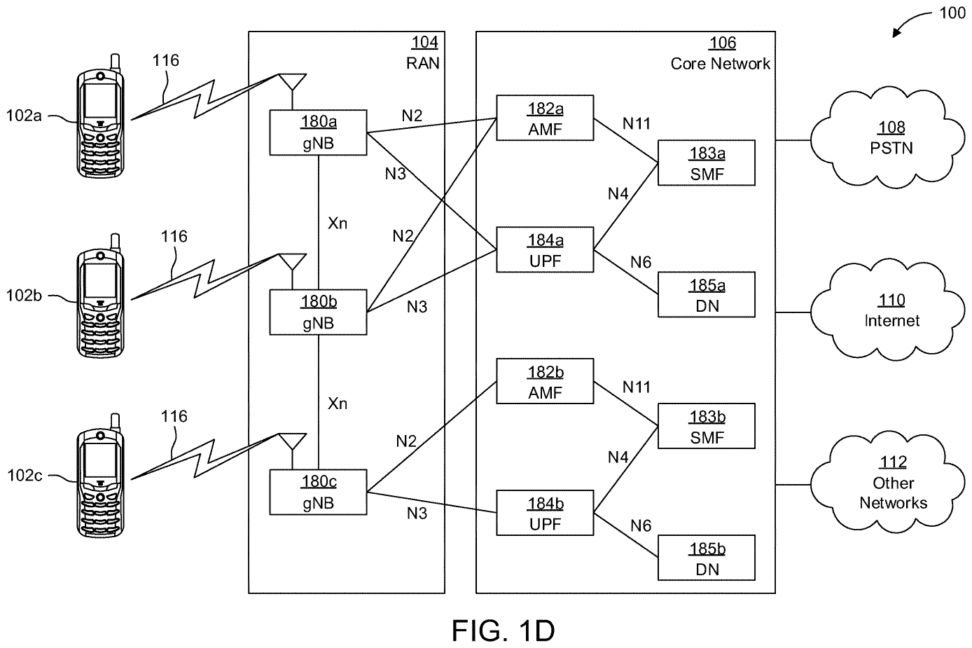

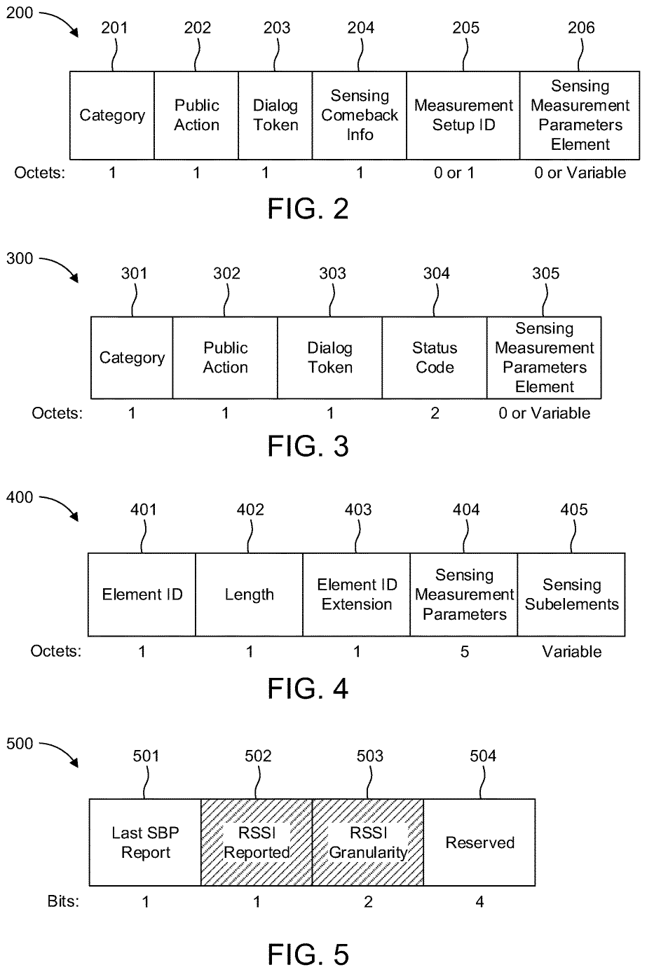

FIG. 2 illustrates an example of a sensing measurement setup request frame action field format. As shown, there may be a frame 200 with one or more fields, such as a Category 201, Public Action 202, Dialog Token 203, Sensing Comeback Info 204, Measurement Setup ID 205, and/or Sensing Measurement Parameters Element 206. While a certain number of octets are shown in the figure, it is intended that these are just for illustration purposes, and the octets may be greater or less than those shown for each field.

Sensing measurement setup may allow for a sensing initiator and a sensing responder to exchange and agree on operational parameters associated with sensing measurement instance(s) of a given Measurement Setup ID. Such a setup may include where a sensing initiator may transmit a Sensing Measurement Setup Request frame as indicated in FIG. 2 to a sensing responder with which it intends to initiate a sensing measurement setup.

FIG. 3 illustrates an example of a sensing measurement setup response frame action field format. As shown, there may be a frame 300 with one or more fields, such as Category 301, Public Action 302, Dialog Token 303, Status Code 304, and/or Sensing Measurement Parameters Element 305. While a certain number of octets are shown in the figure, it is intended that these are just for illustration purposes, and the octets may be greater or less than those shown for each field.

Upon reception of a Sensing Measurement Setup Request frame the sensing responder may transmit a Sensing Measurement Setup Response frame as indicated in FIG. 3 to the sensing initiator which transmitted the Sensing Measurement Setup Request frame.

FIG. 4 illustrates an example of a sensing measurement parameters element format. As shown, there may be a frame 400 with one or more fields, such as Element ID 401, Length 402, Element ID Extension 403, Sensing Measurement Parameters 404, and/or Sensing Subelements 405. While a certain number of octets are shown in the figure, it intended that these are just for illustration purposes, and the octets may be greater or less than those shown for each field.

In some cases, there may be one or more devices, procedures, and/or systems to report SINR and/or RSSI with application-dependent or scenario-dependent granularity in WLAN sensing. In one case, the RSSI per Rx antenna and/or SINR per spatial stream may be reported in a sensing measurement report with different granularities depending on the sensing application/scenario requirement. A sensing initiator may indicate the required granularity for the sensing measurement report statically in the Sensing Measurement Setup or dynamically (e.g., in the NDPA, in the SR2SR Sounding trigger frame, or some other message generally).

In one case, the RSSI per Rx antenna and/or SINR per spatial stream may be reported using one octet per RX antenna and/or per spatial stream such that the encoding of the value of the RSSI and/or SINR depends on the required granularity as indicated in Table 1 for RSSI and in Table 2 for SINR.

In one example, 2-bit encoding may be used such that a granularity value of 0 indicates that the RSSI and/or SINR is reported with a 0.5 dBm and/or 0.5 dB granularity, respectively, and a granularity value of 1 indicates that the RSSI and/or SINR is reported with a 1 dBm and/or 1 dB granularity, respectively, and so on. While specific increments are given in this example, it is intended that a granularity value could be associated with any dBm increment (e.g., preconfigured via a known table, or negotiated during a message exchange). Different increments may be associated with degrees of precisions, as further explained herein.

In such an example, a range of RSSI subfield values or SINR subfield values may be used to indicate the same RSSI and/or SINR in larger granularities. For instance, when the RSSI granularity=3 which maps to a granularity of 3 dBm, the RSSI subfield range of values from 0 to 5 may indicate the RSSI value of −110 dBm. Another example for the SINR subfield when SINR granularity=2 which maps to a granularity of 2 dB, the SINR subfield range of values from 0 to 3 may indicate the SINR value of −10 dB.

TABLE 1
Example 2-bit encoding of the RSSI
application-dependent granularity

RSSI Measured at the Receive Antenna (dBm)
with Different Granularity

| RSSI | Granu- | Granu- | Granu- | Granu- |
|---|---|---|---|---|
| Subfield | larity = 0 | larity = 1 | larity = 2 | larity = 3 |
| value | (0.5 dBm) | (1 dBm) | (2 dBm) | (3 dBm) |
| 0 | −110 | −110 | −110 | −110 |
| 1 | −109.5 | −110 | −110 | −110 |
| 2 | −109 | −109 | −110 | −110 |
| 3 | −108.5 | −109 | −110 | −110 |
| 4 | −108 | −108 | −108 | −110 |
| 5 | −107.5 | −108 | −108 | −110 |
| 6 | −107 | −107 | −108 | −107 |
| . | . | . | . | . |
| . | . | . | . | . |
| . | . | . | . | . |
| 179 | −20.5 | −21 | −20 | −20 |
| 180 | −20 | −20 | −20 | −20 |
| 181-255 | Reserved | Reserved | Reserved | Reserved |

TABLE 2
Example 2-bit encoding of the SINR
application-dependent granularity

SINR Measured for Each Spatial Stream (dB)
with Different Granularity

| SINR | Granu- | Granu- | Granu- | Granu- |
|---|---|---|---|---|
| Subfield | larity = 0 | larity = 1 | larity = 2 | larity = 4 |
| value | (0.5 dB) | (1 dB) | (2 dB) | (4 dB) |
| 0 | −10 | −10 | −10 | −10 |
| 1 | −9.5 | −10 | −10 | −10 |
| 2 | −9 | −9 | −10 | −10 |
| 3 | −8.5 | −9 | −10 | −10 |
| 4 | −8 | −8 | −8 | −10 |
| 5 | −7.5 | −8 | −8 | −10 |
| 6 | −7 | −7 | −8 | −10 |
| 7 | −6.5 | −7 | −8 | −10 |
| . | . | . | . | . |
| . | . | . | . | . |
| . | . | . | . | . |
| 79 | 29.5 | 30 | 30 | 30 |
| 80 | 30 | 30 | 30 | 30 |
| 81-255 | Reserved | Reserved | Reserved | Reserved |

In one case, different encoding tables may be used for different granularities such that each RSSI Subfield value may indicate one and only one RSSI value where the range of used values and reserved values will be different for different granularities.

In one example, as indicated in Table 3 and Table 4, a 2-bit encoding may be used for 0.5 dBm granularity (granularity=0) such that the RSSI subfield range from 0 to 180 is used to encode the RSSI range from −110 dBm to −20 dBm and the range from 181 to 255 is reserved.

TABLE 3
Example 2-bit encoding of the RSSI application-
dependent granularity (Granularity = 0.5 dBm)

| RSSI | RSSI Measured at the Receive Antenna (dBm) |
|---|---|
| Subfield value | (Granularity = 0.5 dBm) |
| 0 | −110 |
| 1 | −109.5 |
| 2 | −109 |
| . | . |
| . | . |
| . | . |
| 179 | −20.5 |
| 180 | −20 |
| 181-255 | Reserved |

TABLE 4
Example 2-bit encoding of the RSSI application-
dependent granularity (Granularity = 1 dB)

| RSSI | RSSI Measured at the Receive Antenna (dBm) |
|---|---|
| Subfield value | (Granularity = 1 dBm) |
| 0 | −110 |
| 1 | −109 |
| 2 | −108 |
| . | . |
| . | . |
| . | . |
| 89 | −21 |
| 90 | −20 |
| 91-255 | Reserved |

In another example, a 2-bit encoding may be used for 1 dBm granularity (granularity=1) such that the RSSI subfield range from 0 to 90 is used to encode the RSSI range from −110 dBm to −20 dBm and the range from 91 to 255 is reserved. Similarly, examples for the SINR Subfield are indicated in Table 5 and Table 6.

TABLE 5
Example 2-bit encoding of the SINR application-
dependent granularity (Granularity = 0.5 dB)

| SINR | SINR Measured for Each Spatial Stream (dB) |
|---|---|
| Subfield value | (Granularity = 0.5 dB) |
| 0 | −10 |
| 1 | −9.5 |
| 2 | −9 |
| . | . |
| . | . |
| . | . |
| 79 | 29.5 |
| 80 | 30 |
| 81-255 | Reserved |

TABLE 6
Example 2-bit encoding of the SINR application-
dependent granularity (Granularity = 1 dB)

| SINR | SINR Measured for Each Spatial Stream (dB) |
|---|---|
| Subfield value | (Granularity = 1 dB) |
| 0 | −10 |
| 1 | −9 |
| 2 | −8 |
| . | . |
| . | . |
| . | . |
| 39 | 29 |
| 40 | 30 |
| 41-255 | Reserved |

In one case, different granularity may be used for different ranges of the RSSI and/or SINR values. Specifically, a granularity may be associated with a specific range of measurements. For example, there may be a granularity value for a first RSSI and/or SINR range (e.g., very small), and there may be a granularity value for a second RSSI and/or SINR range (e.g., small), and there may be a granularity value for a third RSSI and/or SINR range (e.g., medium/large). In this way, different RSSI and/or SINR resolutions may be used for different RSSI and/or SINR ranges of values.

In one case, the reporting of the RSSI and/or SINR may be optional such that it shall be reported only if requested by the sensing initiator. In this case, the sensing initiator may indicate if the RSSI and/or SINR will be reported in the sensing measurement report. Additionally, the sensing initiatory may also indicate what is the required granularity of the RSSI and/or SINR value if the sensing measurement is reported. The sensing initiator may statically indicate this in the Sensing Measurement Setup or dynamically (e.g., in the NDPA, in the SR2SR Sounding trigger frame, or some other message).

FIG. 5 illustrates an example design of a presence and control bitmap field format for the reporting of the RSSI.

In one case, the sensing responder may indicate in the sensing measurement report if the RSSI is reported and the corresponding granularity of the reported RSSI values. This indication may be included in the Presence & Control Bitmap of the Sensing Measurement Report Control field as shown in the example of FIG. 5. The Presence & Control Bitmap of the Sensing Measurement Report Control field 500 may include one or more subfields, such as the RSSI Reported subfield 502 and/or RSSI Granularity subfield 503. The field 500 may also include a last SBP Report subfield 501, and/or a Reserved subfield 504. While a certain number of bits are shown in the figure, it is intended that these are just for illustration purposes, and the bits may be greater or less than those shown for each subfield.

In one example, the RSSI Reported subfield of value 0 may indicate that the RSSI is not reported and the RSSI Reported subfield of value 1 may indicate that the RSSI is reported. In one example, the RSSI Granularity subfield may include a 2-bit encoding of the used granularity in the reported RSSI, for instance RSSI Granularity=0 indicates a granularity of 0.5 dBm, RSSI Granularity=1 indicates a granularity of 1 dBm, RSSI Granularity=2 indicates a granularity of 2 dBm, and RSSI Granularity=3 indicates a granularity of 3 dBm.

It is intended that the values provided herein associated with any example are merely illustrative, and it is intended that any value may be used in place of the example value, such as a value that is preconfigured with an associated meaning.

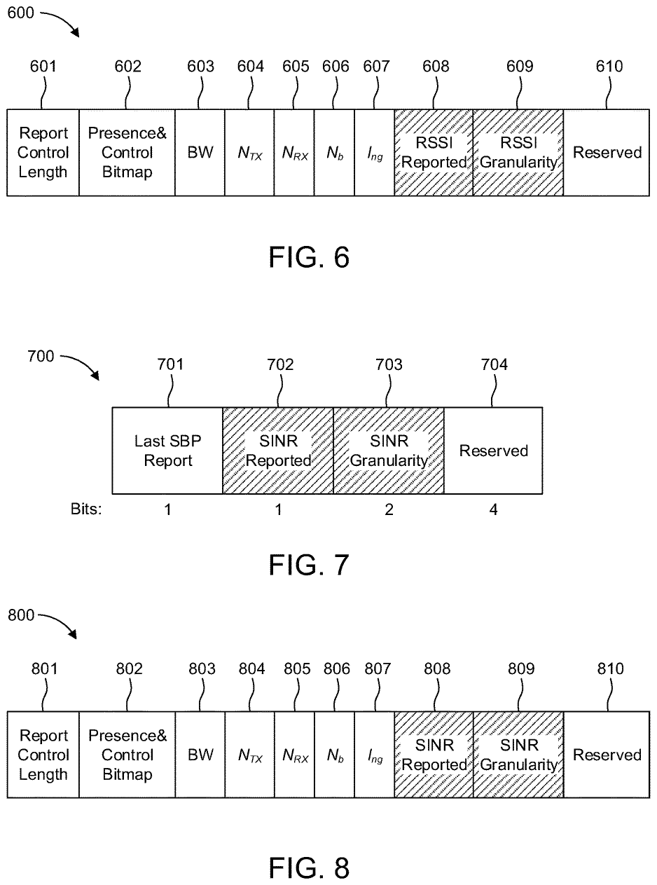

FIG. 6 illustrates an example design of a sensing measurement report control field for the reporting of the RSSI. In one case, as shown, the RSSI Reported subfield 608 and/or the RSSI Granularity subfield 609 may be included in the Sensing Measurement Report Control field 600. This field 600 may also comprise one or more other subfields, such as Report Control Length 601, Presence and Control Bitmap 602, BW 603, N_{TX} 604, NRx 605, Nb 606, Ing 607, and/or reserved 610.

FIG. 7 illustrates an example design of a presence and control bitmap field format for the reporting of the SINR. In one case, the SINR Reported subfield 702 and/or the SINR Granularity subfield 703 may be included in the Presence & Control Bitmap of the Sensing Measurement Report Control field 700 as illustrated in FIG. 7. This field 700 may also comprise one or more other subfields, such as Last SBP Report 701, and/or Reserved 704.

FIG. 8 illustrates an example design of a sensing measurement report control field for the reporting of the SINR. In one case, the SINR Reported subfield 808 and/or the SINR Granularity subfield 809 may be included in the Presence & Control Bitmap of the Sensing Measurement Report Control field 800 as indicated in FIG. 8. This field 800 may also comprise one or more other subfields, such as Report Control Length 801, Presence and Control Bitmap 802, BW 803, N_{TX} 804, NRx 805, Nb 806, Ing 807, and/or Reserved 810.

In one example, the SINR Reported subfield of value 0 may indicate that the SINR is not reported and the SINR Reported subfield of value 1 may indicate that the SINR is reported. In one example, the SINR Granularity subfield may include a 2-bit encoding of the used granularity in the reported SINR, for instance SINR Granularity=0 indicates a granularity of 0.5 dB, SINR Granularity=1 indicates a granularity of 1 dB, SINR Granularity=2 indicates a granularity of 2 dB, and SINR Granularity=3 indicates a granularity of 4 dB.

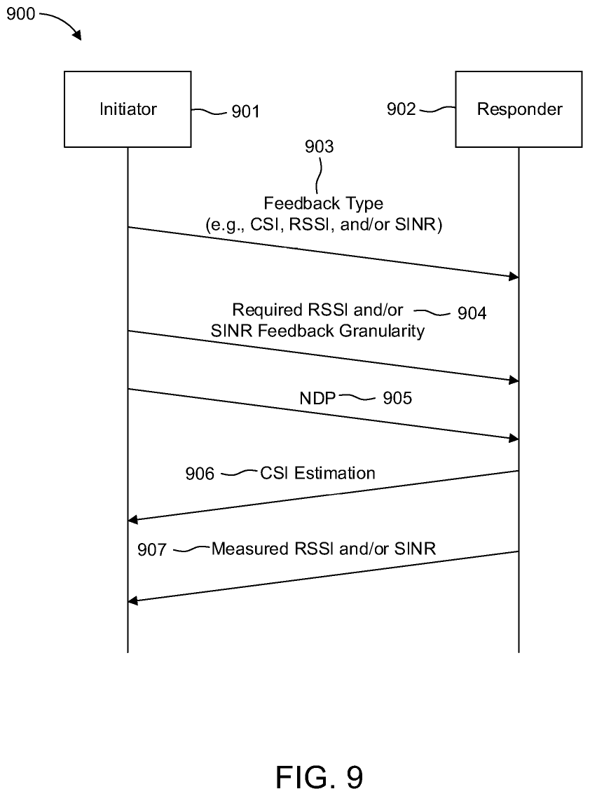

FIG. 9 illustrates an example procedure to indicate if the RSSI and/or SINR measurement is required and the granularity of the measurement. As shown, there may be two devices (e.g., STA, WTRU, AP, and/or any device disclosed herein, etc.), including an initiator 901 and a responder 902. These devices may send one or more messages to each other related to radio measurements, where each message may comprise one or more components or pieces of information (e.g., the fields or frames as disclosed herein, or variations thereof). In one instance, each arrow may represent one or more components of a single message. In another instance each arrow may represent one or more message. In any of these instances, a null data packet (NDP) 905 may be sent (e.g., in addition to, prior to, after, part of, etc.).

Generally, as disclosed herein the NDP is the PHY layer preamble of a PPDU containing no data frame (hence the name null data packet). The NDP may be used to measure the channel and to generate the CSI (Channel State Information) in addition to any other physical measurement of interest such as SINR, RSSI, etc.

In the example illustrated in FIG. 9, the sensing initiator 901 may send a message indicating a requirement. For example, it may be indicated that for certain feedback types 903 there may be a required granularity 904. For example, it may be indicated that the RSSI at each RX antenna and/or the SINR for each spatial stream is required along with the CSI in the sensing measurement report (e.g., that would be sent back by the responder 902). In one case, the sensing initiator 901 may statically indicate that the RSSI and/or the SINR measurement is required in the Sensing Measurement Setup procedure, and this may remain in effect for all the sensing measurement instances associated with this measurement setup before it is terminated. In another case, the sensing initiator may indicate the required RSSI Granularity and/or SINR Granularity if it indicated that the RSSI and/or SINR measurement is required. In one case, the indication for the granularity may imply the requirement of a measurement report (e.g., meaning fewer and/or smaller message(s) can be sent to convey the same thing).

Once the responder 902 receives the indication(s)/message(s), the responder 902 may estimate the CSI and/or perform measurements (e.g., RSSI and/or SINR) according to the negotiated setup (e.g., the received parameters, the indication from the initiator 901, etc.). The responder may send these pieces of information (e.g., CSI estimation 906 and/or measured RSSI and/or SINR 907) back to the initiator 901 (e.g., in one or more messages, where each message may have one or more components, such as frame(s), field(s), subfield(s), etc.).

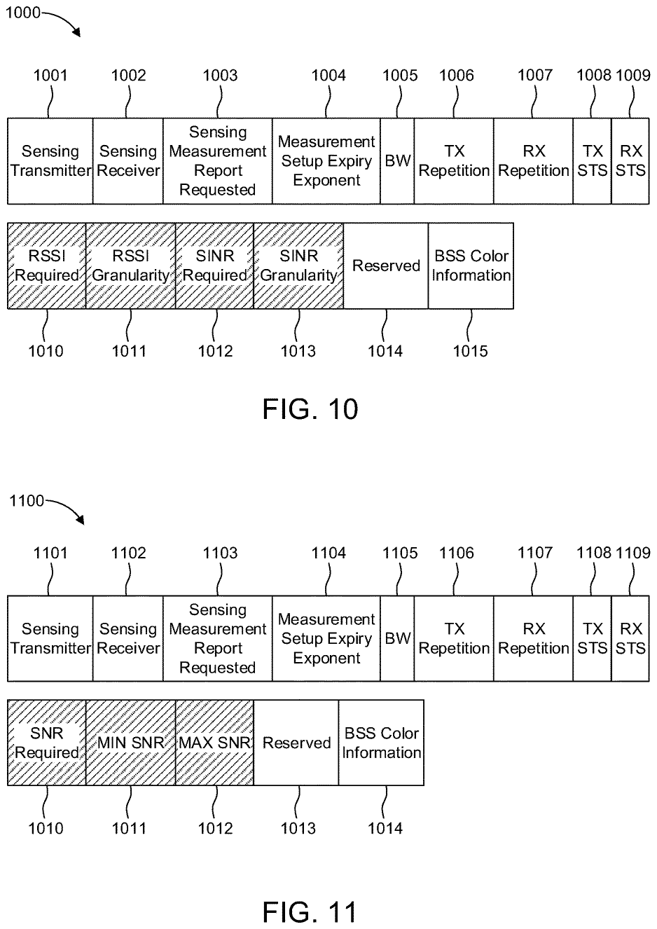

FIG. 10 illustrates an example design of a sensing measurement parameters field format to indicate if the RSSI and/or the SINR is required and the corresponding granularity. In one case, the sensing initiator may indicate in the Sensing Measurement Parameters field of the Sensing Measurement Parameters element (e.g., FIG. 4) of the Sensing Measurement Setup Request frame (e.g., FIG. 2) if the RSSI and/or SINR measurement is required and the granularity of the measurement as illustrated in FIG. 10. As shown, in the field 1000, there may be one or more subfields, such as Sensing Transmitter 1001, Sensing Receiver 1002, Sensing Measurement Report Requested 1003, Measurement Setup Expiry Component 1004, BW 1005, TX Repetition 1006, RX Repetition 1007, TX STS 1008, RX STS 1009, RSSI Required 1010, RSSI Granularity 1011, SINR Required 1012, SINR Granularity 1013, Reserved 1014, and/or BSS Color Information 1015.

In one example, the RSSI Required subfield is set to 0 to indicate that the RSSI measurement shall be included in the sensing measurement report and set to 0 otherwise. The RSSI Granularity subfield is set to a value to indicate in which granularity the RSSI shall be reported if the RSSI Required subfield is set to 0 and is reserved otherwise.

In one example, the SINR Required subfield is set to 0 to indicate that the SINR measurement shall be included in the sensing measurement report and set to 0 otherwise. The SINR Granularity subfield is set to a value to indicate in which granularity the SINR shall be reported if the SINR Required subfield is set to 0 and is reserved otherwise.

In one example, if the RSSI measurement is required by a sensing application (e.g., operating on or known to the sensing initiator), the sensing initiator shall send the Sensing Measurement Setup Request frame with the RSSI Required subfield set to 1 and the RSSI Granularity is set to the required RSSI Granularity value as requested by the corresponding sensing application (e.g., involving different layers of the sensing initiator).

In one example, if the RSSI measurement is not required by a sensing application, the sensing initiator shall send the Sensing Measurement Setup Request frame with the RSSI Required subfield set to 0 and the RSSI Granularity subfield is reserved.

In one example, if the SINR measurement is required by a sensing application, the sensing initiator shall send the Sensing Measurement Setup Request frame with the SINR Required subfield set to 1 and the SINR Granularity is set to the required RSSI Granularity value as requested by the corresponding sensing application.

In one example, if the SINR measurement is not required by a sensing application, the sensing initiator shall send the Sensing Measurement Setup Request frame with the SINR Required subfield set to 0 and the SINR Granularity subfield is reserved.

In one example, if the sensing responder completed a Sensing Measurement Setup successfully with the RSSI Required subfield in the Sensing Measurements Parameters element set to 1, the responder shall send the sensing measurement report with the RSSI Reported subfield set to 1 and the RSSI Granularity subfield is set to the value of the RSSI Granularity as indicated in in the Sensing Measurements Parameters element. Also, the responder may send a single RSSI value for each RX antenna along with the CSI measurements.

In one example, if the sensing responder completed a Sensing Measurement Setup successfully with the SINR Required subfield in the Sensing Measurements Parameters element set to 1, the responder shall send the sensing measurement report with the SINR Reported subfield set to 1 and the SINR Granularity subfield is set to the value of the SINR Granularity as indicated in in the Sensing Measurements Parameters element. Also, the responder may send a single SINR value for each spatial stream along with the CSI measurements.

In one example, the sensing initiator may dynamically indicate that the RSSI and/or the SINR measurement is required either in the NDPA in the NDPA Sounding phase or in the SR2SR Sounding Trigger of the SR2SR Sounding phase. Accordingly, the sensing initiator may indicate the RSSI Granularity and/or SINR Granularity if the corresponding measurement is required.

For context, as it pertains generally to one or more examples herein, it may be noted that the null data packet (NDP) may be sent in a sensing measurement exchange in at least three different ways. First, in the downlink in NDPA sounding phase. Second, in the uplink in a TF (trigger frame) sounding phase. Third, peer-to-peer in an SR2SR (Sensing Responder to Sensing Responder) trigger frame sounding phase. NDPA Sounding phase may be performed by sending an null data packet announcement (NDPA) frame by the AP followed by the transmission of NDP in the downlink. TF Sounding phase may be performed by sending a TF by the AP to trigger the non-AP STA to send the NDP in the uplink. SR2SR Sounding phase may be performed by sending a TF by the AP to trigger a non-AP STA to send the NDP to another non-AP STA.

In one case, the sensing initiator may signal the upper and lower bound of the RSSI, SNR, or SINR in the Sensing Measurement Parameters field such that the sensing responder may encode the measurement (e.g., RSSI, SINR or SNR) value to the corresponding code within a range of values that is known. The range of values may be fixed such that the resolution of the measurement is different for different upper (Max) and lower (Min) bounds of the measurement.

In one example, the initiator may signal an upper value of the SNR as 30 dB and a lower value of the SNR as −10 dB, and assuming only 41 codes are used out of 255 codes available if one octet is used for encoding the measurement value as shown in Table 7. In another example as illustrated in Table 8, the initiator may signal an upper value of the SNR as 20 dB and a lower value of the SNR as 0 dB for the same number of codes (41 codes) which may indicate a different granularity for the SNR measurement. In other examples, similar behavior may be suggested for different measurements such as RSSI (with a unit of dBm) or SINR.

TABLE 7
Exemplary encoding of the SNR with Min and Max values
(Min = −10 and Max = 30 dB)

| SINR | SNR Measured for Each Spatial Stream (dB) |
|---|---|
| Subfield value | (Min = −10 and Max = 30 dB) |
| 0 | <=−10 |
| 1 | −9 |
| 2 | −8 |
| . | . |
| . | . |
| . | . |
| 39 | 29 |
| 40 | >=30 |
| 41-255 | Reserved |

TABLE 8
Exemplary encoding of the SNR with Min and Max values
(Min = 0 and Max = 20 dB)

| SINR | SNR Measured for Each Spatial Stream (dB) |
|---|---|
| Subfield value | (Min = 0 and Max = 20 dB) |
| 0 | <=0 |
| 1 | 0.5 |
| 2 | 1 |
| . | . |
| . | . |
| . | . |
| 39 | 19.5 |
| 40 | >=20 |
| 41-255 | Reserved |

FIG. 11 illustrates an example of a sensing measurement parameters field format to indicate if the SNR is required and the corresponding min and max SNR values. In one case, if the SNR measurement is required by a sensing application, the sensing initiator may send the Sensing Measurement Setup Request frame with the SNR Required subfield set to 1 and the MIN SNR and MAX SNR subfields set to the minimum SNR and the maximum SNR values that are designated by the sensing initiator, respectively, as illustrated in FIG. 11. In one case, similar behavior may be defined for other measurements such as RSSI (e.g., with a unit of dBm) or SINR. In the illustrated example, the field 1100 may have one or more subfields, such as Sensing Transmitter 1101, Sensing Receiver 1102, Sensing Measurement Report Requested 1103, Measurement Setup Expiry Component 1104, BW 1105, TX Repetition 1106, RX Repetition 1107, TX STS 1108, RX STS 1109, SNR Required 1110, MIN SNR 1111, MAX SNR 1112, Reserved 1113, and/or BSS Color Information 1114.

In one case, the RSSI per RX antenna and/or the SNR or SINR per spatial stream may be reported in the sensing measurement report as one value for the entire sensing bandwidth or as an array of values that contains one measurement per each 20 MHz subchannel of the sensing bandwidth. In one example, if the sensing bandwidth is 80 MHz, the sensing responder may report one measurement (e.g., RSSI, SNR, SINR) per the entire 80 MHz. In another example, the sensing responder may instead report an array of 4 values which contains one measurement for each 20 MHz subchannel of the sensing bandwidth, such as the 80 MHz.

In one case, additionally or alternatively, the RSSI per RX antenna and/or the SNR or SINR per spatial stream may be reported in the sensing measurement report as an array of values each for a unit of the sensing bandwidth. The unit of the bandwidth may be a subcarrier, every Nth subcarrier, a group of subcarriers, an RU/MRU of any size or pattern, and/or the like (e.g., some increment value).

In some cases, for WLAN sensing, the sensing measurement may include SINR and/or RSSI measurement. The different granularity to report SINR and/or RSSI may be required in different sensing applications. However, different sensing devices may have different capabilities such that some devices may be able to report the SINR and/or RSSI with a range of granularity. There is a need to address how this can be exchanged between two devices (e.g., an AP and a STA).

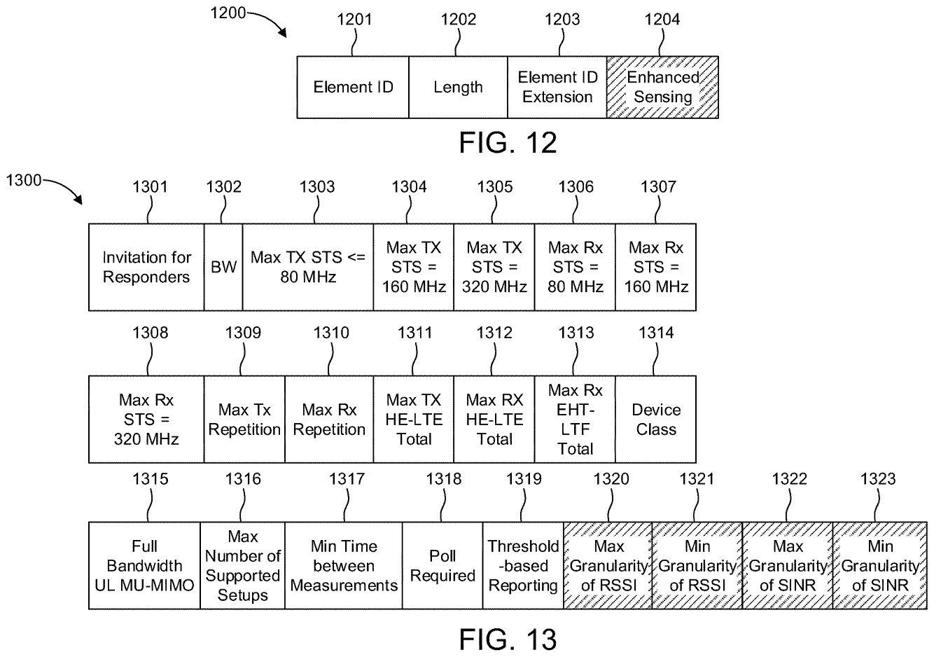

FIG. 12 illustrates an example of enhanced sensing element format. In one case, the sensing device may need to indicate to the sensing initiator the range of SINR and/or RSSI granularity it can support. As shown, there may be one or more fields in this element 1200, such as Element ID 1201, Length 1202, Element ID Extension 1203, and/or Enhanced Sensing 1204.

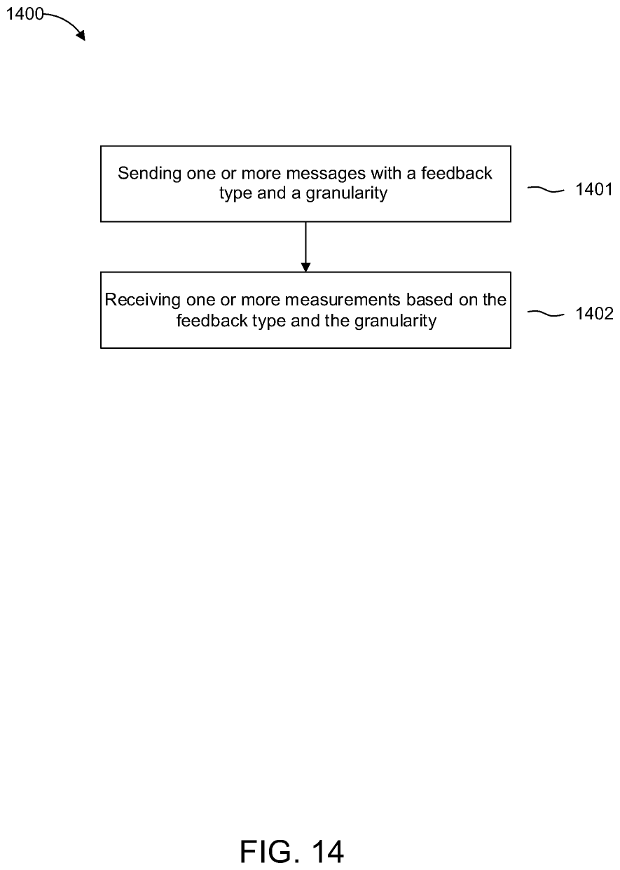

FIG. 13 illustrates an example of enhanced sensing field format, in the Enhanced Sensing element (e.g., of FIG. 12). As shown in field 1300, there may be one or more subfields, such as Max Granularity of RSSI 1320 and/or SINR 1322 and Min Granularity of RSSI 1321 and/or SINR 1323. The Max Granularity of RSSI or SINR subfield may indicate the maximum granularity of RSSI or SINR report this device may support. The Min Granularity of RSSI or SINR subfield may indicate the minimum granularity of RSSI or SINR report this device may support). The field 1300 may include one or more other subfields, such as Invitation for Responders 1301, BW 1302, Max TX STS⇐80 MHz 1303, Max TX STS=160 MHz 1304, Max TX STS=320 MHz 1305, Max Rx STS=80 MHz 1306, Max Rx STS=160 MHz 1307, Max Rx STS=320 MHz 1308, Max Tx Repetition 1309, Max Rx Repetition 1310, Max TX HE-LTE Total 1311, Max RX HE-LTE Total 1312, Max Rx EHT-LTF Total 1313, Device Class 1314, Full Bandwidth UL MU-MIMO 1315, Max Number of Supported Setups 1316, Min Time between Measurements 1317, Poll Required 1318, and/or Threshold-based Reporting 1319.

In one case, the granularity of the RSSI and/or SNR (SINR) may be included in the RXVECTOR parameters. Table 9 gives examples of SNR (or SINR) or RSSI granularity RXVECTOR parameters. It shows that the SNR Granularity parameter follows the same conditions as SNR Parameter in RXVECTOR. When it is present, it contains a single value which indicates what granularity of SNR or what encoding table (e.g., between the actual SNR values and the SNR RXVECTOR parameter values) is used. Similarly, the RSSI Granularity parameter follows the same conditions as RSSI Parameter in RXVECTOR. When it is present, it may contain a single value which indicates what granularity of RSSI or what encoding table (e.g., between the actual RSSI values and the SNR RXVECTOR parameter values) is used.

TABLE 9
Examples of SNR/RSSI granularity RXVECTOR parameters

| Parameter | Condition | Value | TXVECTOR | RXVECTOR |
|---|---|---|---|---|
| SNR | Same condition | Contain a single | N | Y |
| Granularity | as SNR | value which | | |
| | Parameter in | indicates what | | |
| | RXVECTOR | granularity or | | |
| | | what encoding | | |
| | | table (between | | |
| | | the actual SNR | | |
| | | values and the | | |
| | | SNR parameter | | |
| | | value) is used | | |
| RSSI | Same RSSI | Contain a single | N | Y |
| Granularity | condition as RSSI | value which | | |
| | Parameter in | indicates what | | |
| | RXVECTOR | granularity or | | |
| | | what encoding | | |
| | | table (between | | |
| | | the actual SNR | | |
| | | values and the | | |
| | | RSSI parameter | | |
| | | value) is used | | |

In one case, a device may send on or more messages to setup the parameters associated with reporting measurements. A first one or more messages may indicate the type of measurements required. In some instances, there may be an associated parameter(s) of the feedback that is required (e.g., granularity, minimum, maximum, etc.) and also indicated in the one or more messages. The first one or more messages may be acknowledged. The device may receive a response message including one or more of the required measurements. The measurements may adhere to the parameter(s) that was requested. In some cases, a NDP is sent to be the basis of the measurements.

FIG. 14 illustrates an example procedure according to one or more techniques described herein. This procedure 1400 may be carried about by a device, such as those described herein. At 1401 the device may send one or more messages that include a feedback type and a granularity. The feedback type may inherently include a request for feedback. The feedback that is requested may have a specific type and granularity. The type may be more than one type. The granularity may be a minimum, a range, a maximum, a default, or reference to an index where one or more other parameters may ultimately determine the granularity. At 1402, a response may be received by the device with the feedback that was originally requested. The feedback may be of the specified type and the specified granularity, or at least determined based on the one or more messages.

Although the features and elements of the different scenarios, examples, cases, etc. are described in in particular configurations, it is intended that each feature or element may be used alone without the other features and elements of a given scenario/example/case or in various combinations with or without other features and elements of the given scenario/example/case.

Although the solutions described herein are generally described from the perspective of 802.11 WLAN specific protocols, it is intended that the solutions described herein are not restricted to this use case and are applicable to other wireless systems as well, such as 3GPP or the like.

Although SIFS is used to indicate various inter frame spacing in the examples of the designs and procedures, all other inter frame spacing such as RIFS, AIFS, DIFS or other time interval may be applied in a given situation.

Although some values are used as examples to indicate if the RSSI/SINR is required or if the RSSI/SINR is reported, any other value may be used instead to indicate this option.

Although some values are used to indicate the RSSI/SINR granularity, other values may be used instead to indicate the granularity.

Although some RSSI/SINR granularity are provided as examples, other values for the granularity may be used instead.

Long Training Field (LTF) may be any type of predefined sequences that are known at both transmitter and receiver sides.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for use in a device, the method comprising:
sending one or more messages indicating a required feedback type per antenna or spatial stream and a required feedback granularity for the required feedback type, wherein the required feedback type is one or more of channel state information, received signal strength indication, signal to noise ratio, signal to interference, and or noise ratio, and wherein the indicated required feedback granularity specifies a unit of measurement of the required feedback type; and
receiving one or more measurements per antenna or spatial stream based on the one or more messages.

2. The method of claim 1, wherein the required feedback granularity is an increment of the required feedback type, wherein the increment has a degree of precision.

3. The method of claim 1, wherein a channel state information estimation is received based on the one or more messages.

4. The method of claim 1, wherein the unit of measurement of the required feedback type is specified in decibels.

5. The method of claim 1, wherein the one or more measurements is provided in an increment specified by the required feedback granularity.

6. The method of claim 1, wherein one or more null data packets (NDPs) is sent after sending the one or more messages.

7. The method of claim 6, wherein the one or more measurements is based on the one or more NDPs.

8. A device, the device comprising:
a processor operatively coupled to a transceiver, the processor and transceiver configured to send one or more messages indicating a required feedback type per antenna or spatial stream and a required feedback granularity for the required feedback type, wherein the required feedback type is one or more of channel state information, received signal strength indication, signal to noise ratio, signal to interference, or noise ratio, and wherein the indicated required feedback granularity specifies a unit of measurement of the required feedback type; and
the processor and transceiver configured to receive one or more measurements per antenna or spatial stream based on the one or more messages.

9. The device of claim 8, wherein the required feedback granularity is an increment of the required feedback type, wherein the increment has a degree of precision.

10. The device of claim 8, wherein a channel state information estimation is received based on the one or more messages.

11. The device of claim 8, wherein the unit of measurement of the required feedback type is specified in decibels.

12. The device of claim 8, wherein the one or more measurements is provided in an increment specified by the required feedback granularity.

13. The device of claim 8, wherein one or more null data packets (NDPs) is sent after sending the one or more messages.

14. The device of claim 8, wherein the one or more measurements is based on the one or more NDPs
